(19) United States
(12) Patent Application Publication
(10) Pub. No.: US 2024/0282216 A1
(43) Pub. Date: Aug. 22, 2024

(54) IN-VEHICLE SYSTEM AND FUNCTION LEARNING PRESENTATION METHOD

(71) Applicant: DENSO CORPORATION, Kariya-city (JP)

(72) Inventors: Masafumi NOHARA, Kariya-city (JP); Masato UTSUNOMIYA, Kariya-city (JP); Kazuki IZUMI, Kariya-city (JP); Asaki UMEZAWA, Kariya-city (JP); Keiji OKAMOTO, Kariya-city (JP); Yo KITAMURA, Kariya-city (JP); Haozhou LI, Kariya-city (JP); Taro KOBAYASHI, Kariya-city (JP)

(21) Appl. No.: 18/652,427

(22) Filed: May 1, 2024

Related U.S. Application Data
(63) Continuation of application No. PCT/JP2022/038057, filed on Oct. 12, 2022.

(30) Foreign Application Priority Data
Nov. 12, 2021 (JP) 2021-184859
Mar. 22, 2022 (JP) 2022-045422

(51) Int. Cl. G09B 19/16

(52) U.S. Cl. CPC G09B 19/167

(57) ABSTRACT

An in-vehicle system includes a driving proficiency acquisition unit acquiring a driving proficiency level of a driver, a driving proficiency determination unit determining the driving proficiency level of the driver; and a function learning presentation unit presenting learning of functions to the driver in stepwise manner according to a determination result of the driving proficiency level of the driver.

### CROSS REFERENCE TO RELATED APPLICATIONS

The present application is a continuation application of International Patent Application No. PCT/JP2022/038057 filed on Oct. 12, 2022, which designated the U.S. and claims the benefit of priority from Japanese Patent Application No. 2021-184859 filed on Nov. 12, 2021, and Japanese Patent Application No. 2022-045422 filed on Mar. 22, 2022. The entire disclosures of all of the above applications are incorporated herein by reference.

### TECHNICAL FIELD

The present disclosure relates to an in-vehicle system and a function learning presentation method.

### BACKGROUND

There has been known a device that performs a learning support for a driver during traveling state by presenting learning contents suitable for the driver.

### SUMMARY

The present disclosure provides an in-vehicle system. The in-vehicle system includes a microcomputer that is configured to: acquire a driving proficiency level of a driver; determine the driving proficiency level of the driver; and present learning of functions to the driver in stepwise manner according to a determination result of the driving proficiency level of the driver.

### BRIEF DESCRIPTION OF DRAWINGS

Objects, features and advantages of the present disclosure will become apparent from the following detailed description made with reference to the accompanying drawings. In the drawings:

FIG. 1 is a functional block diagram showing a configuration of a data communication system according to a first embodiment;

FIG. 2 is a functional block diagram showing a configuration of an in-vehicle system;

FIG. 3 is a functional block diagram of a central ECU,

FIG. 4 is a diagram showing a stepwise learning of functions;

FIG. 5 is a flowchart showing a function learning presentation process;

FIG. 6 is a functional block diagram of a central ECU according to a second embodiment;

FIG. 7 is a flowchart showing a function suppression process;

FIG. 8 is a flowchart showing a function pre-learning presentation process according to a third embodiment;

FIG. 9 is a functional block diagram of a central ECU according to a fourth embodiment; and

FIG. 10 is a flowchart showing a vehicle setting information change process.

### DETAILED DESCRIPTION

In recent vehicle market, vehicles are equipped with various functions. In some driving operations, drivers are required to have knowledge about the vehicle functions and perform complex operations for fully using the functions installed in the vehicle. A driver who has little interest in driving or who drives the vehicle not so frequently may find it difficult to remember complex operations or knowledge for operating the vehicle. Thus, the driver may have a difficult in efficiently using various functions of the vehicle. In recent years, the vehicle manufacturers try to show how to use the vehicle functions in various ways, such as, by introducing use of functions not only in manual book but also in a wide variety of media. However, the driver who is not interested in the functions has low motivation to learn about how to use the functions of vehicle. As a result, most of the vehicle functions remain in non-use state.

With consideration of the above described circumstance, it is expected that the driver learns about the functions installed in the vehicle. In a known art, a learning method presents learning content that is not related to the functions installed in the vehicle. Thus, this kind of method cannot make the driver to learn about the functions installed in the vehicle.

According to an aspect of the present disclosure, an in-vehicle system includes a driving proficiency acquisition unit acquiring a driving proficiency level of a driver; a driving proficiency determination unit determining the driving proficiency level of the driver; and a function learning presentation unit presenting learning of functions to the driver in stepwise manner according to a determination result of the driving proficiency level of the driver.

The driving proficiency level of driver is acquired and determined, and function learning is presented to the driver in stepwise manner according to the determination result of driving proficiency level. By presenting the learning of functions to the driver in stepwise manner, it is possible to expect the driver to learn the functions in stepwise manner. Accordingly, the driver can have a sense of accomplishment for the level-up in learning of vehicle-related functions. This configuration enables the driver to appropriately learn the vehicle-related functions installed to the vehicle.

The following will describe embodiments of the present disclosure with reference to the accompanying drawings. In the following description, descriptions of same configurations as the ones described in the preceding embodiment may be omitted for simplification.

### First Embodiment

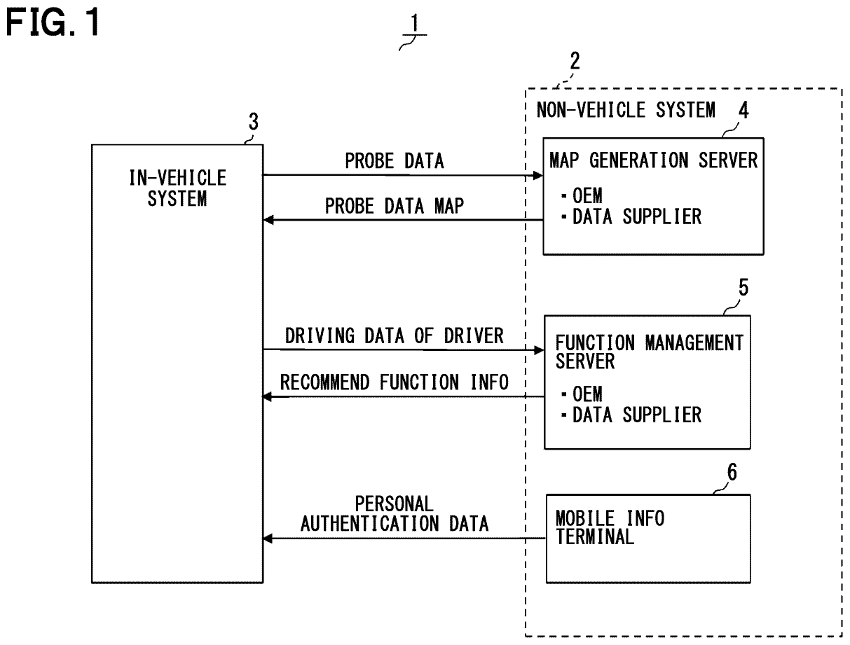

The following will describe a first embodiment of the present disclosure with reference to FIG. 1 to FIG. 5. As shown in FIG. 1, a data communication system 1 includes a non-vehicle system 2, which is not equipped to the vehicle, and an in-vehicle system 3, which is equipped to the vehicle. The non-vehicle system 2 includes a map generation server 4, a function management server 5, and a mobile information terminal 6. For example, the mobile information terminal 6 is a smartphone 6a. Each of the map generation server 4, the function management server 5, and the mobile information terminal 6 is capable of performing data communication with the in-vehicle system 3 via a communication network including, for example, a digital communication line. The mobile information terminal 6 is capable of performing data communication with the in-vehicle system 3 while being brought into a compartment of the vehicle. The in-vehicle system 3, the map generation server 4, and the function management server 5 each has multiple-to-one relationship. That is, multiple in-vehicle systems 3 can be connected to one map generation server 4 for data communication, and multiple in-vehicle systems 3 can be connected to one function management server 5 for data communication.

The map generation server 4 is a server managed by an OEM (i.e., a vehicle manufacturer), a data supplier, and the like. The map generation server has a function of integrating multiple probe data pieces to generate a probe data map. When the map generation server 4 receives and acquires the probe data transmitted from the in-vehicle system 3, the map generation server 4 integrates the multiple probe data pieces to generate a probe data map. For example, each time the map generation server 4 receives and acquires the probe data piece transmitted from the in-vehicle system 3, the map generation server 4 sequentially updates the probe data map by sequentially reflecting the planimetric feature information included in the acquired probe data piece on the latest probe data map stored at that time.

When a condition for transmitting the probe data map is satisfied, the map generation server 4 transmits the latest probe data map stored at that time to the in-vehicle system 3. For example, the map generation server 4 manages the probe data map in units of segments corresponding to each section. When the map generation server 4 receives and acquires an host vehicle position transmitted from the in-vehicle system 3, the map generation server 4 specifies the segment of the probe data map corresponding to the acquired host vehicle position, and transmits the specified segment of probe data map via the communication network to the in-vehicle system 3, which is a transmission source of the host vehicle position.

The function management server 5 is a server managed by the OEM, the data supplier, and the like. The function management server 5 manages functions related to the vehicle. When the function management server 5 receives and acquires personal authentication data transmitted from the mobile information terminal 6, the function management server 5 performs personal authentication based on the acquired personal authentication data. Upon receiving and acquiring the driving data of driver, which is transmitted from the in-vehicle system 3, the function management server 5 specifies recommend functions suitable for the driver based on the acquired driving data of driver. The function management server 5 analyzes the driving technique of driver based on the driving data of driver. When the function management server 5 determines that a technique for keeping the traveling lane is unstable, the function management server 5 specifies that a lane keeping assist (hereinafter referred to as LKA) and a lane tracing assist (hereinafter referred to as LTA) are effective for the driving operation of the driver. LKA and LTA correspond to driving assist functions. Then, the function management server 5 specifies the LKA and LTA as the functions to be recommended to the driver When the function management server 5 specifies the recommend function, the function management server 5 transmits recommend function information regarding the specified recommend function to the in-vehicle system 3 and the mobile information terminal 6.

When the in-vehicle system 3 and the mobile information terminal 6 receive and acquire the recommend function information transmitted from the function management server 5, the in-vehicle system 3 and the mobile information terminal 6 notify the driver of the acquired recommend function information and present the recommend function to the driver. When the recommend function is presented by the in-vehicle system 3 in the compartment of the vehicle, the driver can recognize the recommend function specified by the function management server 5. The recommend function is also presented by the mobile information terminal 6 so that the recommend function specified by the function management server 5 can be recognized outside the vehicle. Note that the recommend function is not limited to LKA or LTA. For example, the recommend function may include a function that is effective for the driving operation of driver.

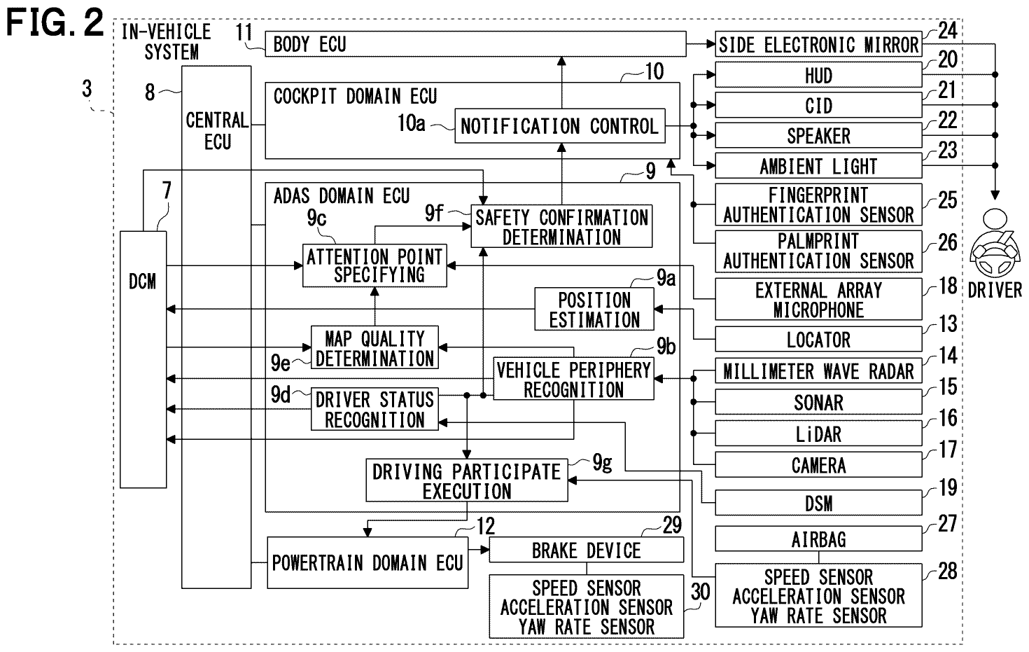

As shown in FIG. 2, the in-vehicle system 3 includes a data communication module (hereinafter referred to as DCM) 7, a central electronic control unit (ECU) 8, and an advanced driver assistance system (ADAS) domain ECU 9, a cockpit domain ECU 10, a body ECU 11, and a powertrain domain ECU 12.

Each of the DCM 7 and the ECUS 8 to 12 includes a microcomputer having a central processing unit (CPU), a read only memory (ROM), a random access memory (RAM), and an input output interface (I/O). The microcomputer executes a computer program stored in a non-transitory tangible storage medium to execute process corresponding to the computer program, and controls an overall operation of the DCM 7 and the ECUS 8 to 12. The microcomputer has the same meaning as a processor. The non-transitory tangible storage medium may share its hardware with another computer resource. The DCM 7 and each ECU 8 to 12 cooperate to control the overall operation of the in-vehicle system 3.

The DCM 7 has a vehicle-to-everything (V2X) communication function as a vehicle communication device, and performs a vehicle communication control for data communication with an infrastructure equipment that includes the map generation server 4 and the function management server 5.

The central ECU 8 integrally manages the ADAS domain ECU 9, the cockpit domain ECU 10, and the powertrain domain ECU 12. The ADAS domain ECU 9 includes a vehicle position estimation unit 9a, a vehicle periphery recognition unit 9b, an attention point specifying unit 9c, a driver status recognition unit 9d, a map quality determination unit 9e, a safety confirmation determination unit 9f, and a driving participate execution unit 9g. The cockpit domain ECU 10 includes a notification control unit 10a.

The locator 13 calculates position coordinates using various parameters included in satellite signals transmitted from global navigation satellite system (GNSS), corrects the calculated position coordinates using detection results of a gyro sensor, a vehicle speed sensor, and the like. Then, the locator 13 outputs the corrected position coordinates to the vehicle position estimation unit 9a. The GNSS is a general term for global navigation satellite system, and includes various systems such as GPS (Global Positioning System), GLONASS (Global Navigation Satellite System), Galileo, BeiDou, and IRNSS (Indian Regional Navigational Satellite System). When the position coordinates are input from the locator 13, the vehicle position estimation unit 9a estimates the position of host vehicle using the input position coordinates, and outputs the estimated vehicle position to the DCM 7.

A millimeter wave radar 14 radiates millimeter waves toward periphery of the host vehicle to sense a periphery of the host vehicle, and outputs the detection result to the vehicle periphery recognition unit 9b. The millimeter wave radar 14 has advantages of high straightness, miniaturization of circuit and antenna design, high distance resolution and high angular resolution by using wide range bandwidth, and resistance to environmental changes such as weather. A sonar 15 emits, for example, ultrasonic waves to the periphery of host vehicle to sense the periphery of host vehicle, and outputs the detection result to the vehicle periphery recognition unit 9b. The sonar 15 has an advantage of reflecting light on a glass surface or a water surface.

A LIDAR (Light Detection and Ranging) 16 emits laser lights toward the periphery of host vehicle to sense the periphery of the host vehicle, and outputs the detection result to the vehicle periphery recognition unit 9b. The LiDAR 16 has an advantage of reflecting light on a non-metal surface, and can be detected even at night or in rainfall. A camera 17 includes an image sensor such as a charge coupled device (CCD) or a complementary metal oxide semiconductor (CMOS). The camera 17 captures an image of the periphery of host vehicle, and outputs the captured camera image to the vehicle periphery recognition unit 9b. The millimeter wave radar 14, the sonar 15, the LiDAR 16, and the camera 17 correspond to autonomous sensors. It is not necessary to provide all of the millimeter wave radar 14, the sonar 15, the LiDAR 16, and the camera 17 to the vehicle. At least one of these autonomous sensors may be provided to the vehicle. For example, a different type of autonomous sensor may be provided to the vehicle separately from the millimeter wave radar 14, the sonar 15, the LiDAR 16, and the camera 17.

When the detection result is input from the millimeter wave radar 14, the detection result is input from the sonar 15, the detection result is input from the LIDAR 16, or the camera image is input from the camera 17, the vehicle periphery recognition unit 9b recognizes the periphery of host vehicle using the input detection result and camera image, and outputs the recognized periphery information indicating the periphery of host vehicle to the DCM 7, the map quality determination unit 9e, the safety confirmation determination unit 9f, and the driving participate execution unit 9g. The periphery information includes, as static information, planimetric feature information such as positions and types of marking lines, stop lines, crosswalks, and the like painted on a road surface, positions and types of traffic lights, road signs, and the like erected from the road surface, road widths, road types, the number of lanes, and the like. The periphery information includes, as dynamic static information, positions of pedestrians, bicycles, and oncoming vehicles.

When the host vehicle position is input from the vehicle position estimation unit 9a and the periphery information indicating the periphery of host vehicle is input from the vehicle periphery recognition unit 9b, the DCM 7 transmits probe data to the map generation server 4 via the communication network. In the probe data, the input host vehicle position, the periphery information indicating the periphery of host vehicle, and corresponding time are associated with one another. The DCM 7 transmits the probe data to the map generation server 4 via the communication network, for example, at a time when the travel distance of the host vehicle reaches a certain distance, or at a time when the elapsed period from last time transmission reaches a certain period, or the like.

In the DCM 7, when the probe data map acquiring unit 2a receives the probe data map transmitted from the map generation server 4, the probe data map acquiring unit 2a outputs the received probe data map to the attention point specifying unit 9c and the map quality determination unit 9e.

When the map quality determination unit 9e receives the periphery information indicating the periphery of host vehicle from the vehicle periphery recognition unit 9b and receives the probe data map from the DCM 7, the map quality determination unit 9e collates the probe data map with the periphery information indicating the periphery of host vehicle and determines a quality of the probe data map. For example, the map quality determination unit 9e determines whether the planimetric feature information indicated by the probe data map matches the periphery information around the host vehicle indicated by the detection result of the autonomous sensor, and determines the quality of probe data map based on the determination result. Specifically, the map quality determination unit 9e determines whether the position and the type of planimetric feature indicated by the probe data map match the position and the type of feature included in the periphery information around the host vehicle indicated by the detection result of the autonomous sensor, and determines the quality of probe data map based on the determination result.

For example, the map quality determination unit 9e digitizes a matching degree between the planimetric feature information indicated by the probe data map and the periphery information around the host vehicle indicated by the detection result of the autonomous sensor, and compares the digitized numerical value with a predetermined threshold. The map quality determination unit 9e determines that the probe data map has high quality when a difference between the planimetric feature information indicated by the probe data map and the periphery information around the host vehicle indicated by the detection result of the autonomous sensor is small and the numerical value indicating the matching degree is equal to or greater than the predetermined threshold value. When the map quality determination unit 9e determines that the probe data map has high quality, the map quality determination unit 9e outputs the probe data map determined to have high quality to the attention point specifying unit 9c. When the map quality determination unit 9e determines that the difference between the planimetric feature information indicated by the probe data map and the periphery information around the host vehicle indicated by the detection result of the autonomous sensor is large and the numerical value indicating the matching degree is less than the predetermined threshold value, the map quality determination unit 9e determines that the probe data map has low quality.

An external array microphone 18 outputs, to the attention point specifying unit 9c, audio information obtained by collecting sounds around the host vehicle. The external array microphone 18 also corresponds to an autonomous sensor similarly to the millimeter wave radar 14, the sonar 15, the LiDAR 16, and the camera 17 described above. When the probe data map is input from the map quality determination unit 9e, the attention point specifying unit 9c specifies an attention point and outputs the specifying result to the safety confirmation determination unit 9f. The attention point is a point where the driver needs to check about safety during driving. For example, the attention point may be a blind spot of an intersection or the like. When sound information is input from the external array microphone 18, the attention point specifying unit 9c specifies an attention point with reference to the input sound information. When the probe data map is not input from the map quality determination unit 9e, the attention point specifying unit 9c specifies the attention point using the detection result of the autonomous sensor, and outputs the specification result to the safety confirmation determination unit 9f.

A driver status monitor (DSM, registered trademark) 19 that monitors a status of the driver captures a face image of the driver using a driver monitor camera, determines a face direction, a line-of-sight direction, head swing, and the like from the face image of the driver, and outputs the determination result to the driver status recognition unit 9d.

When the determination result is input from the DSM 19, the driver status recognition unit 9d recognizes the driver status using the determination result, and outputs driver status information indicating the recognized driver status to the DCM 7, the safety confirmation determination unit 9f, and the driving participate execution unit 9g.

When the safety confirmation determination unit 9f receives the periphery information indicating the periphery of host vehicle from the vehicle periphery recognition unit 9b and receives the driver status information from the driver status recognition unit 9d, the safety confirmation determination unit 9f determines whether to activate an alert with reference to the received periphery information indicating the periphery of the host vehicle and the driver status information. The safety confirmation determination unit 9f determines whether the line of sight of the driver is directed in a direction of the attention point when the attention point occurs, determines whether the driver performs the safety confirmation based on the driver status, and determines whether it is necessary to activate the alert.

When it is determined that the line of sight direction of the driver is directed to the attention point, the safety confirmation determination unit 9f determines that activation of alert is not necessary. When it is determined that the line of sight direction of the driver is not directed to the attention point, the safety confirmation determination unit 9f determines that it is necessary to activate an alert, and outputs a notification instruction to the notification control unit 10a.

When the notification control unit 10a receives the notification instruction from the safety confirmation determination unit 9f, the notification control unit 10a outputs an activation instruction to a head-up display (hereinafter referred to as HUD) 20, a center information display (hereinafter referred to as CID) 21, a speaker 22, and an ambient light 23, and outputs the notification instruction to the body ECU 11. The notification control unit 10a outputs an alert at a position close to the line of sight of the driver in the HUD 20, the CID 21, the speaker 22, the ambient light 23, and a side electronic mirror 24. Then, the notification control unit 10a notifies the driver of safety confirmation non-execution information indicating that the driver has not yet performed the safety confirmation.

For example, the alert may be a message, an icon that prompts safety confirmation for the attention point. For example, when the line of sight of the driver is directed forward in the traveling direction of the host vehicle, the notification control unit 10a displays a message, an icon, or the like in front of the driver on the HUD 20. For example, when the line of sight of the driver is directed right forward in the traveling direction of the host vehicle, the notification control unit 10a displays, on the HUD 20, a message, an icon, or the like on the right forward portion of the driver. For example, when the line of sight of the driver is directed left forward in the traveling direction of the host vehicle, the notification control unit 10a displays, on the HUD 20, a message, an icon, or the like on the left forward portion of the driver. For example, the notification control unit 10a may control the CID 21 to display, for example, a message, an icon, or the like urging the safety check of the attention point. In addition, the notification control unit 10a may control the speaker 22 to output, for example, a sound of a message for prompting performing of the safety confirmation for the attention point. By outputting the alert in the above-described manner, it is possible to make the driver aware that attention should be made to the attention point without distraction.

When the recommend function information transmitted from the function management server 5 is received by the in-vehicle system 3 as described above, the notification control unit 10a controls the HUD 20 or the CID 21 to display the received recommend function information, or controls the speaker 22 to output the sound, so that the notification control unit 10a presents the recommend function specified by the recommend function information to the driver.

A fingerprint authentication sensor 25 senses the driver's fingerprint and outputs a detection result to the cockpit domain ECU 10. A palmprint authentication sensor 26 senses the driver's palmprint and outputs a detection result to the cockpit domain ECU 10. When the cockpit domain ECU 10 receives detection results from the fingerprint authentication sensor 25 and the palmprint authentication sensor 26, the cockpit domain ECU 10 authenticate the driver using the input detection results, and outputs the authentication result to the central ECU 8.

A sensor group 28 connected to an airbag 27 includes, for example, a vehicle speed sensor detecting a vehicle speed, an acceleration sensor detecting an acceleration of the vehicle, and a yaw rate sensor detecting a yaw rate of the vehicle. The sensor group outputs the detection results to the driving participate execution unit 9g. The sensor group 28 may be connected to the ADAS domain ECU 9 or the central ECU 8.

When the driving participate execution unit 9g receives the periphery information indicating the periphery of host vehicle from the vehicle periphery recognition unit 9b, receives the driver status information from the driver status recognition unit 9d, and receives the detection results from the sensor group 28 connected to the airbag 27, the driving participate execution unit 9g determines whether it is necessary to participate in the driving operation, which is being executed by the driver, with reference to the periphery information indicating the periphery of host vehicle, the driver status information, and the detection result, which are input from the various sources. For example, the driving participate execution unit 9g determines whether the line of sight of the driver is directed to the traveling direction of the host vehicle, determines whether the traveling direction of the host vehicle is dangerous, determines whether the speed, the acceleration, and the yaw rate of host vehicle are normal, and the like. Then, the driving participate execution unit 9g determines whether it is necessary to participate in the driving operation being performed by the driver based on the above determination results.

For example, the driving participate execution unit 9g may determine that there is no need to participate in the driving operation being performed by the driver, when it is determined that (i) the line of sight of the driver is directed to the traveling direction of the host vehicle, (ii) the traveling direction of the host vehicle is not dangerous, (iii) the speed, the acceleration, and the yaw rate of the host vehicle are normal, or (iv) the driving operation is properly performed by the driver. For example, the driving participate execution unit 9g may determine that it is necessary to participate in the driving operation being performed by the driver, when it is determined that (i) the line of sight of the driver is not directed to the traveling direction of the host vehicle, (ii) the traveling direction of the host vehicle is dangerous, (iii) the speed, the acceleration, and the yaw rate of the host vehicle are not normal, or (iv) the driving operation not properly performed by the driver. When determining that it is necessary to participate in the driving operation being performed by the driver, the driving participate execution unit 9g outputs a driving participate instruction to the powertrain domain ECU 12.

When the driving participate instruction is input from the driving participate execution unit 9g, the powertrain domain ECU 12 outputs the driving participate instruction to a brake device 29. For example, a sensor group 30 connected to the brake device 29 may include a vehicle speed sensor detecting a speed of the host vehicle, an acceleration sensor detecting an acceleration of the host vehicle, and a yaw rate sensor detecting a yaw rate of the host vehicle. The sensor group 30 outputs the detection results to the brake device 29. The sensor group 30 may be attached to the powertrain domain ECU 12 or the central ECU 8. When receiving the driving participate instruction from the powertrain domain ECU 12, the brake device 29 performs a collision damage reduction brake (hereinafter, referred to as Autonomous Emergency Braking (AEB)) control using, for example, detection results of the sensor group 30. In addition to the AEB control, steering control, attitude control, or the like may be performed as the participation in the driving operation. For example, electronic stability control (ESC) may be performed as the participation in the driving operation.

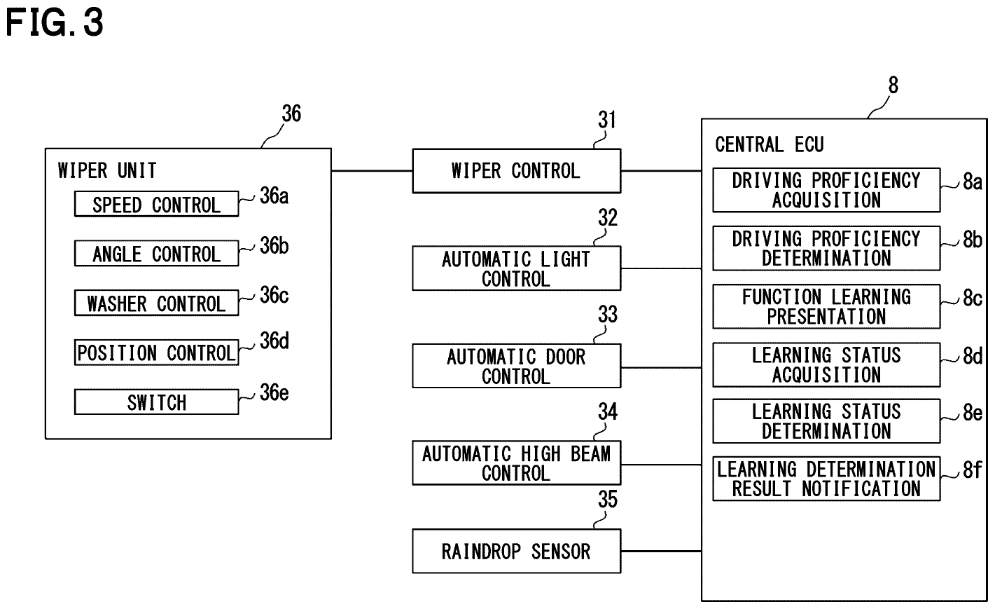

As shown in FIG. 3, a wiper control unit 31, an automatic light control unit 32, an automatic door control unit 33, an automatic high beam control unit 34, and a raindrop sensor 35 are connected to the central ECU 8. The wiper control unit 31 is connected to a wiper unit 36. The wiper unit 36 includes a speed control unit 36a, an angle control unit 36b, a washer control unit 36c, a position control unit 36d, and a switch 36e. The wiper control unit 31 outputs a wiper control instruction to the wiper unit 36 and controls the operation of wiper unit 36.

The automatic light control unit 32 outputs an automatic light control instruction to an automatic light unit (not shown) and controls the operation of automatic light unit. The automatic door control unit 33 outputs an automatic door control instruction to an automatic door unit (not shown) and controls the operation of automatic door unit. The automatic high beam control unit 34 outputs an automatic high beam control instruction to an automatic high beam unit (not shown) and controls the operation of automatic high beam unit. The raindrop sensor 35 outputs a detection signal to the central ECU 8 in response to detection of rainfall.

The central ECU 8 includes a driving proficiency acquisition unit 8a, a driving proficiency determination unit 8b, a function learning presentation unit 8c, a learning status acquisition unit 8d, a learning status determination unit 8e, and a learning determination result notification unit 8f. A function learning presentation program executed by the central ECU 8 corresponds to each of the functional units 8a to 8f. The central ECU 8 is also referred to as a control unit.

The driving proficiency acquisition unit 8a acquires vehicle data, such as correction frequency of acceleration/deceleration control, correction frequency of steering control, occurrence frequency of lane departure alert (hereinafter referred to as LDA), occurrence frequency of collision damage mitigation braking (hereinafter referred to as AEB). AEB is abbreviation of autonomous emergency braking. The driving proficiency acquisition unit 8a acquires, as driving ability data, a degree of inattentiveness or composure during driving operation, from the determination result of face image of the driver The driving proficiency acquisition unit 8a acquires the vehicle data and the driving ability data, for a certain period of time. In this case, the certain period may be set to a proper period, such as the period from when the driver purchased the vehicle, or the last several days from current time.

When the driving proficiency level of the driver is acquired by the driving proficiency level acquisition unit 8a, the driving proficiency level determination unit 8b determines the acquired driving proficiency level of the driver. The driving proficiency determination unit 8b determines that the proficiency level of driver is relatively high, for example, when (i) the correction frequency of acceleration/deceleration control or the correction frequency of steering control is relatively low, or (ii) the driver is less distracted or keeps composure during driving operation. The driving proficiency determination unit 8b determines that the proficiency level of driver is relatively high when the driver is using an appropriate function according to the periphery situation. In this case, the function being used by the driver may be determined by the driving proficiency determination unit 8b. For example, in the case of intermittent wiper function, the driving proficiency determination unit 8b determines that the driving proficiency of driver is relatively high when the driver appropriately sets a wiper switch on/off, wiper speed, etc. according to a situation of rainfall.

When the driving proficiency determination unit 8b determines that (i) the correction frequency of acceleration/deceleration control or the correction frequency of steering control is relatively high, or (ii) the driver is distracted or has no composure during driving operation, the driving proficiency determination unit 8b may determine that the driving proficiency level of driver is relatively low. The driving proficiency determination unit 8b may determine the functions being used by the driver during the driving operation. In response to determining that the driver is not using the appropriate functions according to the periphery situation, the driving proficiency determination unit 8b may determine that the driving proficiency of driver is relatively low. In the case of intermittent wiper function, when the driver fails to properly set the wiper switch on/off or wiper speed according to the situation of rainfall, the driving proficiency determination unit 8b may determine that the driver's driving proficiency level is relatively low.

For the functions other than the above-described intermittent wiper function, the driving proficiency determination unit 8b may determine in similar manner. For example, regarding the headlight function, when the driver appropriately sets on/off of the headlight according to a brightness of periphery environment, the driving proficiency determination unit 8b may determine that the driving proficiency level of driver is relatively high. When the driver fails to properly set the headlight function, the driving proficiency determination unit 8b may determine that the driving proficiency level of driver is relatively low. For the function of turning on or off the light switch when entering into or exiting from a tunnel, the driving proficiency determination unit 8b may determine in similar manner. For example, when the driver appropriately turns on or turns off the light switch according to an entrance time or an exit time of the tunnel, the driving proficiency determination unit 8b may determine that the driving proficiency level of driver is relatively high. When the driver fails to properly turn on or turn off the light switch of headlight, the driving proficiency determination unit 8b may determine that the driving proficiency level of driver is relatively low.

When the driving proficiency level of driver is determined by the driving proficiency determination unit 8b, the function learning presentation unit 8c presents learning of function to the driver in stepwise manner according to the determination result of the driving proficiency level. The function learning presentation unit 8c compares the driver's driving proficiency level with a predetermined level set in advance. When the driving proficiency level of driver has not reached the predetermined level, the function learning presentation unit 8c presents learning of function to the driver in stepwise manner. In this case, presenting learning of function in stepwise manner means presenting functions to be learned by the driver in a gamification manner in bird's eye view. This means that each time the driver masters one function in one stage, the driver is presented with the learning of next stage function. By learning the functions in stepwise manner, the driver can feel a sense of accomplishment with level-up.

The function learning presentation unit 8c presents functions to be learned by the driver in a stepwise manner when a safety of driving operation is secured, such as when the vehicle is in a stopped state, for example. The function learning presentation unit 8c determines the driver's schedule by acquiring calendar information, and does not present function learning to the driver when the driver is busy. The function learning presentation unit 8c presents the function learning to the driver when the driver has spare time. The function learning presentation unit 8c determines the driver's physical condition by acquiring the driver's biological information, and does not present function learning to the driver when the driver's physical condition is not stable. The function learning presentation unit 8c presents the learning function to the driver when the driver's physical condition is in a stable state.

As a specific method for presenting function learning to the driver, the function learning presentation unit 8c displays a message inquiring whether to perform the function learning on the CID 21 at a time of turning on the ignition switch or motor, and displays YES or NO button that can be selected by the driver. The driver can approve the learning by pressing YES button, and can refuse the learning by pressing NO button. In addition to display of message on the CID 21 inquiring about the execution of learning, the function learning presentation unit 8c may output the message as a sound from a speaker so that the driver can select execution of learning by voice recognition. As another example, the function learning presentation unit 8c may enable the driver to select whether to perform the learning based on voice recognition of driver in chatbot manner based on daily conversation detected in the compartment.

The learning status acquisition unit 8d acquires a learning status of the function. When the learning status of one function is acquired by the learning status acquisition unit 8d, the learning status determination unit 8e determines the learning status of the acquired function. For example, in the case of intermittent wiper function, the learning status determination unit 8e stores, in advance, an ideal intermittent wiper operation model according to each rain situation. The learning status determination unit 8e determines the rain situation based on the detection results of the raindrop sensor 35 and weather information acquired from outside the vehicle, and then compares the operation state of intermittent wiper set by the driver using the operation model corresponding to the rain situation. Based on the comparison result, the learning status determination unit 8e determines whether the driver is using the intermittent wiper function appropriately.

When the learning status determination unit 8e determines that a difference between the intermittent wiper operation state set by the driver and the operation model is relatively small, the learning status determination unit 8e determines that the driver is using the intermittent wiper function appropriately corresponding to the rain situation. In this case, the learning status determination unit determines that the driver has learned the intermittent wiper function and the learning status of intermittent wiper function has reached a predetermined level. When the learning status determination unit 8e determines that a difference between the intermittent wiper operation state set by the driver and the operation model is relatively large, the learning status determination unit 8e determines that the driver is using the intermittent wiper function inappropriately corresponding to the rain situation. In this case, the learning status determination unit determines that the driver has not yet learned the intermittent wiper function and the learning status of intermittent wiper function has not reached the predetermined level.

When the learning status of one function is determined by the learning status determination unit 8e, the learning determination result notification unit 8f notifies the driver of the determination result. For example, in the case of intermittent wiper function, the learning determination result notification unit 8f notifies the driver that the driver has learned the intermittent wiper function or has not yet learned the intermittent wiper function. The learning determination result notification unit 8f notifies the determination result for the learning status of function to the driver, thereby making the driver recognize that the function has been learned or that the function has not been learned yet.

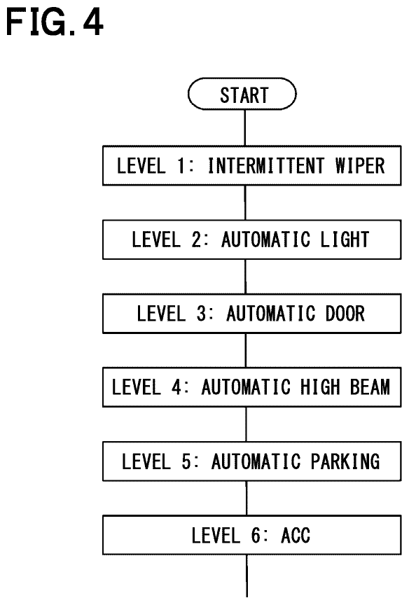

When the learning status of one function reaches the predetermined level, the function learning presentation unit 8c presents learning of next function to the driver. As shown in FIG. 4, the function learning presentation unit 8c sets intermittent wiper as level 1, sets automatic light as level 2, sets automatic door to level 3, sets automatic high beam as level 4, sets automatic parking as level 5, and sets adaptive cruise control (hereinafter referred to as ACC) as level 6. When determining that the learning status of intermittent wiper of level 1 reaches the predetermined level, the function learning presentation unit 8c presents the automatic light of level 2 as the next function to be learned. The same applies hereafter. When determining that the learning status of automatic light of level 2 reaches the predetermined level, the function learning presentation unit 8c presents the automatic door of level 3 as the next function to be learned. Thus, the driver sequentially learns each function of intermittent wiper, automatic light, automatic door, automatic high beam, automatic parking, and ACC. Each time the learning status reaches the predetermined level, the level is increased and the function of next level is presented to the driver for learning purpose.

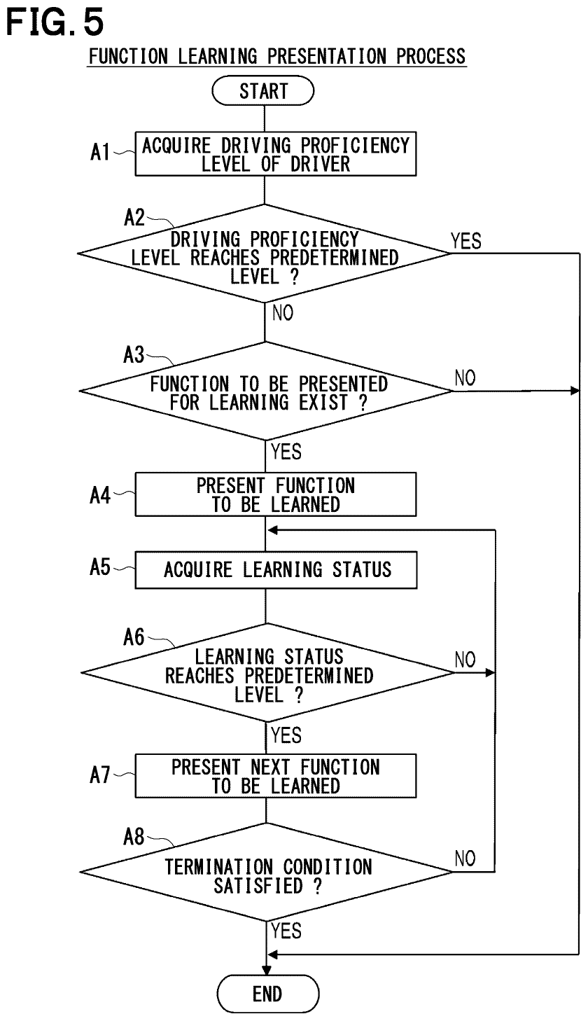

The following will describe an operation of the above-described configuration with reference to FIG. 5. The in-vehicle system 3 performs a function learning presentation process by executing a function learning presentation program. The time for performing the function learning presentation process is set as, for example, when a certain period of time has elapsed since the purchase of vehicle, or at the time when the vehicle is purchased. When the function learning presentation process is performed in response to elapse of a certain period from the purchase of vehicle, the driver's driving proficiency level will be acquired during that certain period. When the function learning presentation process is performed at the purchase time of vehicle, the driver's driving proficiency level is not yet acquired. In this case, it is determined that the driver's driving proficiency level has not reached the predetermined level.

The in-vehicle system 3 starts the function learning presentation process when a start condition of the function learning presentation process is satisfied. When the in-vehicle system 3 starts the function learning presentation process, the in-vehicle system 3 acquires vehicle data, the driver's driving ability data, and the driver's driving proficiency level in A1 (corresponding to driving proficiency acquisition shown in A1). After acquiring the driver's driving proficiency level, the in-vehicle system 3 compares the acquired driver's driving proficiency level with a predetermined level set in advance in A2 (corresponding to driving proficiency determination shown in A2).

When the in-vehicle system 3 determines that the acquired driver's driving proficiency level reaches the predetermined level (A2: YES), the in-vehicle system 3 ends the function learning presentation process. When the in-vehicle system 3 determines that the acquired driver's driving proficiency level has not reached the predetermined level (A2: NO), the in-vehicle system 3 determines whether there is a function to be presented for learning purpose in A3. When the in-vehicle system 3 has already presented all learning functions from the level 1 of intermittent wiper to the level 6 of ACC shown in FIG. 4, the in-vehicle system 3 determines that there is no function to be presented for learning purpose. When the functions from level 1 of intermittent wiper to level 6 of ACC has not been presented for learning purpose, in other words, when presentation for function learning is in the middle, the in-vehicle system 3 determines that there is a function to be presented for learning purpose.

When the in-vehicle system 3 determines that there is no function to be presented for learning purpose (A3: NO), the in-vehicle system 3 ends the function learning presentation process. When the in-vehicle system 3 determines that there is a function to be presented for learning purpose (A3: YES), the in-vehicle system 3 presents the function for learning purpose in A4 (corresponding to a learning presentation procedure shown in A4). For example, when learning of intermittent wiper function of level 1 is not yet presented, the in-vehicle system 3 presents learning of the intermittent wiper function of level 1. For example, when the learning of intermittent wiper function of level 1 has been presented and the learning status of intermittent wiper function of level 1 reaches the predetermined level, the in-vehicle system 3 may present the automatic light function of level 2 for learning purpose.

The in-vehicle system 3 acquires the learning status by acquiring the usage status of the function for which learning has been presented in A5, and compares the learning status of acquired function with the predetermined level set in advance in A6. For example, when the intermittent wiper function of level 1 is presented, the in-vehicle system 3 compares the operation state of intermittent wiper operated by the driver with the operation model corresponding to the rain situation as described above. Then, the in-vehicle system 3 determines whether the driver is using the intermittent wiper function appropriately based on the comparison result.

When the in-vehicle system 3 determines that the driver can use the intermittent wiper function appropriately corresponding to the rain situation, the in-vehicle system 3 determines that the driver has learned the intermittent wiper function of level 1 and the learning status of intermittent wiper function of level 1 has reached the predetermined level (A6: YES). When the learning status determination unit 8e determines that the driver fails to use the intermittent wiper function appropriately corresponding to the rain situation, the in-vehicle system 3 determines that the driver has not yet learned the intermittent wiper function and the learning status of intermittent wiper function has not yet reached the predetermined level (A6: NO).

When the in-vehicle system 3 determines that the learning status of one function has reached the predetermined level, the in-vehicle system 3 presents the next function to be learned to the driver in A7. In this case, the in-vehicle system 3 may display, for example, a message of “learning of intermittent wiper at level 1 has been cleared. The learning proceeds to automatic light at level 2” on the CID 21 or output the message as a sound from the speaker 22.

The in-vehicle system 3 determines whether a termination condition of function learning presentation process is satisfied in A8. In response to determining that the termination condition of function learning presentation process being not satisfied (A8: NO), the process returns to A5 and repeats A5 and subsequent process. When the driver has learned the intermittent wiper function at level 1, the in-vehicle system 3 presents learning of automatic light at level 2, and determines whether the driver uses the automatic light function appropriately. When the driver has learned the automatic light function at level 2, the in-vehicle system 3 presents learning of automatic door at level 3, and determines whether the drive uses the automatic door function appropriately. When the driver has learned the automatic door function at level 3, the in-vehicle system 3 presents learning of automatic high beam at level 4, and determines whether the drive uses the automatic high beam function appropriately. When the in-vehicle system 3 determines that the termination condition of function learning presentation process is satisfied (A8: YES), the function learning presentation process is ended.

The above-described first embodiment provides following operational effects.

The in-vehicle system 3 acquires and determines the driver's driving proficiency level, and presents function to be learned to the driver in stepwise manner according to the determination result of the driving proficiency level of driver. By stepwisely presenting, to the driver, the functions to be learned by the driver according to the determination result of driving proficiency of driver, it is possible to expect the driver to learn the functions in stepwise manner. Thus, the driver can feel a sense of accomplishment as level-up of the function learning. This configuration enables the driver to appropriately learn the functions installed in the vehicle.

In the in-vehicle system 3, learning of function is stepwisely presented to the driver under a condition that the safety of driving operation is secured. That is, presentation of function learning to the driver is not performed under a situation where the safety of driving operation is not secured. Presentation of function learning to the driver is performed only under a situation where the safe of driving operation is secured. Thus, safety of driving operation can be appropriately secured and the learning of functions can be presented to the driver in stepwise manner.

The in-vehicle system 3 acquires and determines the learning status of function, and notifies the determination result of learning status of function. Thus, the driver can be appropriately notified about whether the driver has learned the function as the learning status of function.

In the in-vehicle system 3, in response to determining that the learning status of one function has reached the predetermined level, learning of the next function is presented to the driver. By presenting the learning of next functions to the driver, learning of a wide variety of functions can be presented to the driver in stepwise manner.

### Second Embodiment

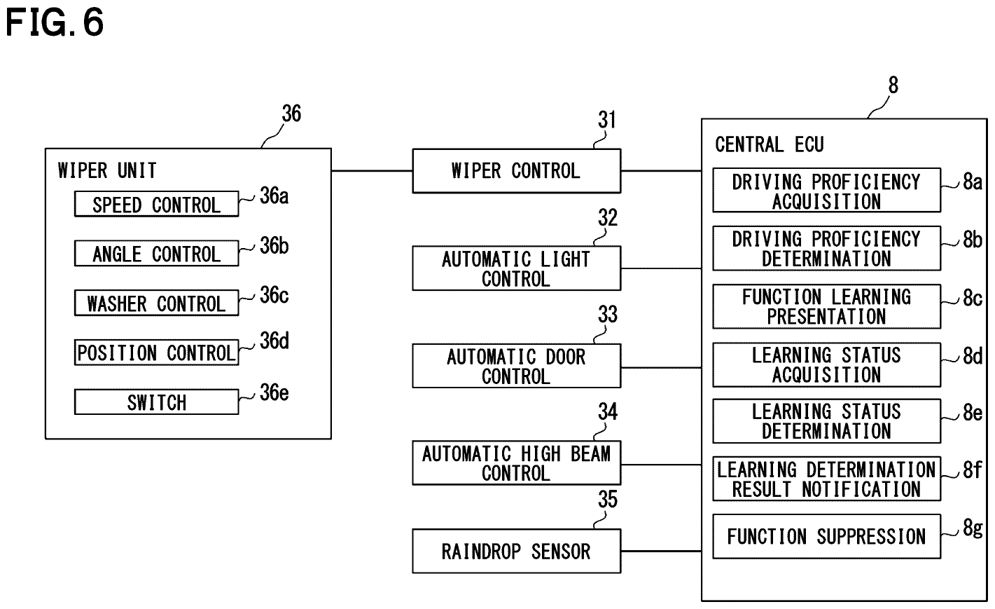

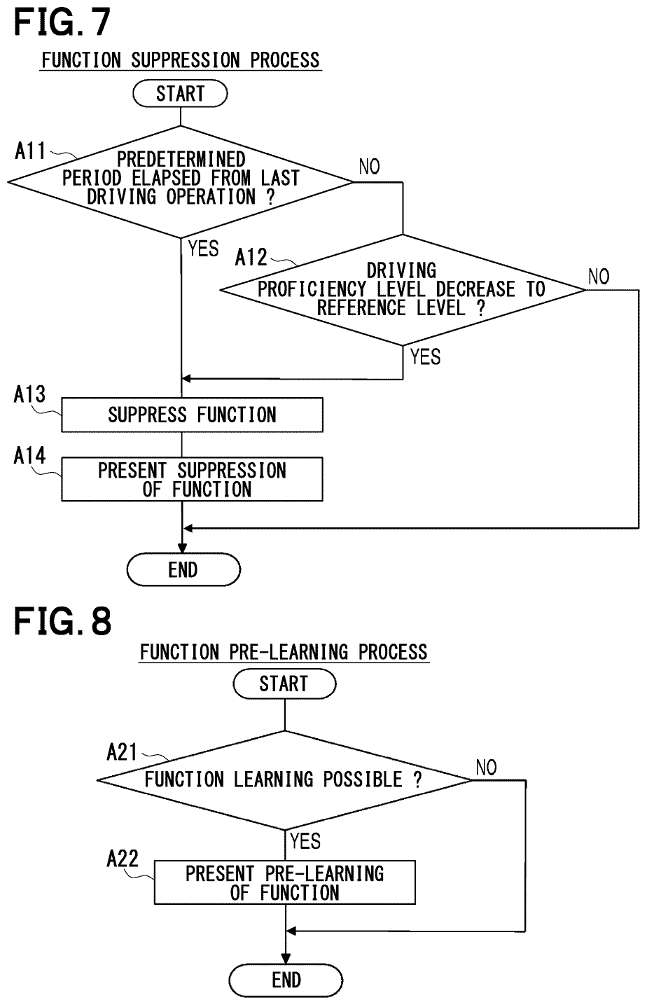

The following will describe a second embodiment with reference to FIG. 6 and FIG. 7. The second embodiment is made with consideration of a case where the driver does not drive for a long period of time or a case where the driver's driving proficiency level decreases. In this case, the central ECU 8 includes a function suppression unit 8g in addition to the units 8a to 8f described in the first embodiment.

The function suppression unit 8g monitors the period of time that has been elapsed since the driver's last driving operation. In response to determining that a predetermined period of time has elapsed since the driver's last driving operation, the function suppression unit suppresses the available functions allowed to the driver. In this case, the predetermined period may be set to a fixed period, or may be set to a variable period depending on the driver's driving proficiency level history. When the history of driver's driving proficiency level is relatively high, it can be assumed that there is a relatively high possibility that the driver is familiar with the use of functions. Thus, the predetermined period may be set to be relatively long. When the history of driver's driving proficiency level is relatively low, it can be assumed that there is a relatively low possibility that the driver is familiar with the use of functions. Thus, the predetermined period may be set to be relatively short. The function suppression unit 8g suppresses the function when the driving proficiency determination unit 8b determines that the driver's driving proficiency level has decreased to a preset reference level.

The function suppression unit 8g may suppress the functions by reducing the number of display windows on the meter device or resetting a home screen of the CID 21, thereby simplifying the information presented to the driver or simplifying the operation. When a function is suppressed by the function suppression unit 8g, the function learning presentation unit 8c presents the suppression of function to the driver.

The following will describe an operation of the above-described configuration with reference to FIG. 7. The in-vehicle system 3 starts a function suppression process when a start condition of the function suppression process is satisfied. When the in-vehicle system 3 starts the function suppression process, the in-vehicle system 3 determines whether a predetermined period of time has passed since the driver's last driving operation is made in A11. Then, the in-vehicle system 3 determines whether the driver's driving proficiency level has decreased to the reference level in A12. When the in-vehicle system 3 determines that the predetermined period of time has elapsed since the driver's last driving operation (A11: YES), or when the in-vehicle system 3 determines that the driver's driving proficiency level has decreased to the reference level (A12: YES), the in-vehicle system 3 suppresses the function in A13 and presents the suppression of function to the driver in A14. Then, the function suppression process is ended.

The above-described second embodiment provides following operational effects.

In the in-vehicle system 3, when a predetermined period of time has elapsed since the driver's last driving operation, or when the driver's driving proficiency level has decreased to the reference level, the function is suppressed and the function suppression is presented to the driver. When a predetermined period of time has elapsed since the driver's last driving operation or when the driver's driving proficiency level has decreased, it is assumed that the driver is unlikely to be able to fully utilize the functions. Thus, it is possible to avoid a situation where a user is unnecessarily provided with the functions that cannot be fully used. By presenting the suppression of function to the driver, it is possible to present to the driver that use of unnecessary functions has been suppressed.

### Third Embodiment

The following will describe a third embodiment with reference to FIG. 8. The third embodiment presents pre-learning of a function to the driver in response to determining that learning of the function is possible according to the determination result of driving proficiency level.

The function suppression unit 8g determines whether learning of function is possible according to the determination result of driving proficiency level of the driver. When the function suppression unit 8g determines that learning of function is possible, the function suppression unit 8g presents the pre-learning of function to the driver. For example, when the function suppression unit 8g specifies that a route to the destination includes a highway in the navigation function, and determines that learning of ACC function is possible based on the determination result of the driver's driving proficiency, pre-learning of ACC function is presented to the driver. The function suppression unit 8g presents pre-learning of the function to the driver using a simulation during driving operation, for example, by displaying a moving image of ACC function on the CID 21 or displaying a graphic of the steering wheel switch on the meter device.

The following will describe an operation of the above-described configuration with reference to FIG. 8. The in-vehicle system 3 starts a function pre-learning presentation process when the start condition of the function pre-learning presentation process is satisfied. When the in-vehicle system 3 starts the function pre-learning presentation process, the in-vehicle system 3 determines whether the function can be learned according to the determination result of driving proficiency level in A21. When the in-vehicle system 3 determines that pre-learning of the function is possible (A21: YES), the in-vehicle system 3 presents the pre-learning of function to the driver in A22, and ends the pre-learning presentation process of the function.

The above-described first embodiment provides following operational effects.

The in-vehicle system 3 determines whether learning of function is possible according to the determination result of driving proficiency level. In response to determining that learning of function is possible, the pre-learning of the function is presented to the driver. Prior to presenting function learning to the driver, pre-learning of function is presented to the driver. Thus, the driver can appropriately learn the function by the pre-learning of the function.

### Fourth Embodiment

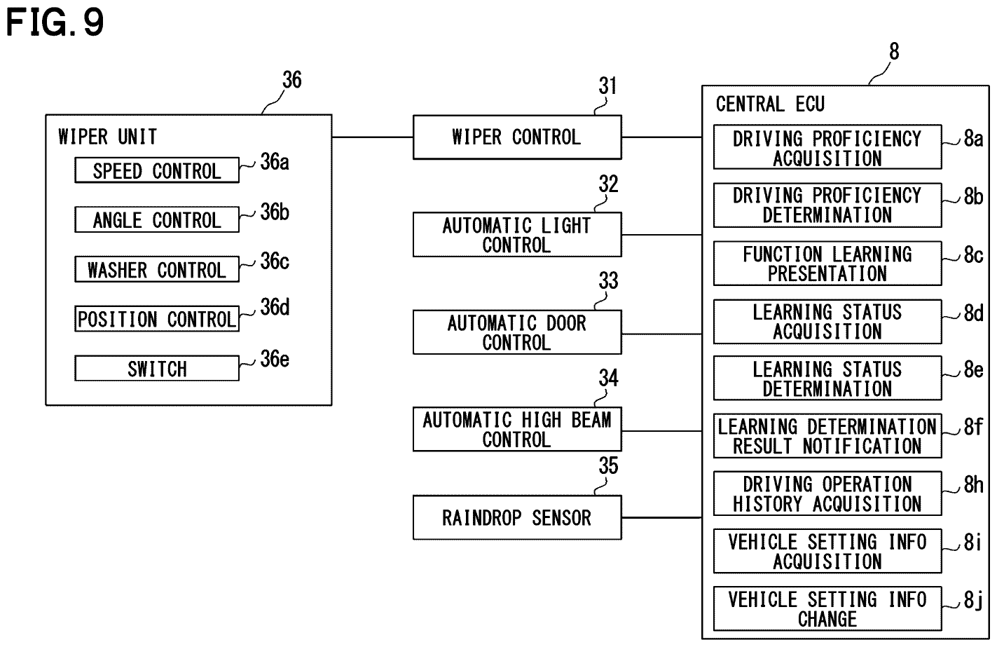

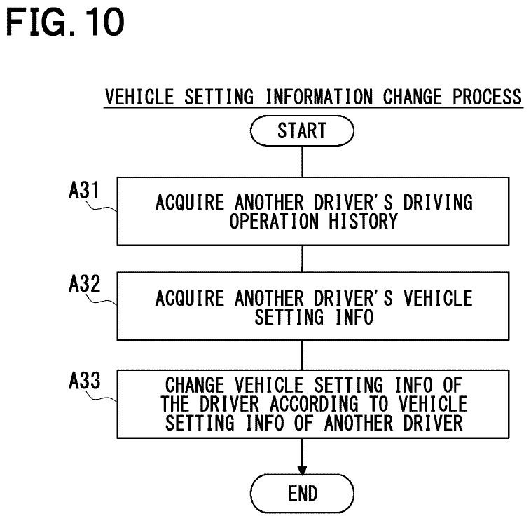

The following will describe a fourth embodiment with reference to FIG. 9 and FIG. 10. In the fourth embodiment, the in-vehicle system acquires vehicle setting information of another driver from driving operation history of another driver, and the vehicle setting information of the driver is changed in accordance with the acquired vehicle setting information of another driver. In this case, the central ECU 8 includes a driving operation history acquisition unit 8h, a vehicle setting information acquisition unit 8i, and a vehicle setting information changing unit 8j, in addition to the units 8a to 8f described in the first embodiment.

The driving operation history acquisition unit 8h acquires the driving operation history of another driver. Another driver is a person who has ridden and operated the host vehicle, or a person who has ridden and operated a vehicle of the same model as the model of host vehicle.

When the driving operation history acquisition unit 8h acquires the driving operation history of another driver, the vehicle setting information acquisition unit 8i acquires another driver's vehicle setting information from the acquired driving operation history of another driver. The vehicle setting information acquisition unit 8i acquires, as the vehicle setting information of another driver, an inter-vehicle distance during automatic driving, a magnitude and activation time of deceleration control, a magnitude and activation time of acceleration control, or the like.

When the vehicle setting information of another driver is acquired by the vehicle setting information acquisition unit 8i, the vehicle setting information changing unit 8j changes the driver's vehicle setting information to follow the acquired vehicle setting information of another driver. In this case, the vehicle setting information changing unit 8j changes the driver's vehicle setting information according to at least one of the driver's driving proficiency level, the driver's preference, and the driver's viewpoint direction. When changing the driver's vehicle setting information according to the driver's driving proficiency level, the vehicle setting information changing unit 8j may activate specific safety related functions for safety securing purpose if the driver is a beginner. When changing the driver's vehicle setting information according to the driver's preference, the vehicle setting information changing unit 8j may set the timing of deceleration control to be earlier if the driver prefers earlier timing for the deceleration control. When changing the driver's vehicle setting information according to the driver's viewpoint direction, the vehicle setting information changing unit 8j may set the driver's vehicle setting information to match the driver's own driving if the driver is looking ahead, and the vehicle setting information changing unit 8j may set the driver's vehicle setting information to match another person's driving if the driver is looking one of front seats. For example, suppose that another person wearing AR goggles is sitting on a seat adjacent to the driver. When the driver is looking ahead, the driving is switched to match to the driver. When the driver is looking the adjacent seat, the driving is switched to match another person's driving together with virtual images.

The following will describe an operation of the above-described configuration with reference to FIG. 10. The in-vehicle system 3 starts a vehicle setting information change process when a start condition for the vehicle setting information change process is satisfied. When the in-vehicle system 3 starts the vehicle setting information change process, the in-vehicle system 3 acquires the driving operation history of another driver in A31, and acquires another driver's vehicle setting information from the acquired driving operation history of another driver in A32. The in-vehicle system 3 changes the driver's vehicle setting information in accordance with the acquired vehicle setting information of another in A33, and ends the vehicle setting information change process.

The above-described fourth embodiment provides following operational effects.

The in-vehicle system 3 acquires the driving operation history of another driver, acquires vehicle setting information of another driver from the driving operation history of another driver, and the vehicle setting information of the driver is changed in accordance with the acquired vehicle setting information of another driver. Thus, the driver's vehicle setting information can be changed to follow the vehicle setting information of another driver.

### Other Embodiments

While the present disclosure has been described based on the above embodiments, the present disclosure is not limited to the embodiments or structures described herein. The present disclosure includes various modification examples and equivalents thereof. Various combinations and configurations, as well as other combinations and configurations including more, less, or only a single element, are within the scope and spirit of the present disclosure.

The control unit and the method thereof described in the present disclosure may be implemented by a dedicated computer configured by a processor and a memory programmed to execute one or more functions embodied by a computer program. Alternatively, the control unit and the method thereof described in the present disclosure may be implemented by a dedicated computer configured by a processor including one or more dedicated hardware logic circuits. Alternatively, the control unit and the method thereof described in the present disclosure may be implemented by one or more dedicated computers configured by a combination of (i) a processor and a memory programmed to execute one or more functions and (ii) a processor including one or more hardware logic circuits. The computer program may be stored in a computer-readable non-transitory tangible storage medium as instructions to be executed by a computer.

The execution time of function learning presentation process is not limited to when a certain period of time has elapsed since purchase of the vehicle, or when the vehicle is purchased. For example, the execution time of function learning presentation process may be set as when a test driving is performed before purchase of the vehicle. When the function learning presentation process is executed in the test driving, it is possible to obtain the learning status determination result before actual purchase of the vehicle. Based on the determination result, it is possible to flexibly handle a situation, such as changing the purchase vehicle to another vehicle or another model. That is, if it is difficult to fully utilize the functions even after the learning, it is possible to consider changing the purchase vehicle to another vehicle or another model. When the vehicle is changed, the learning status determination result of the vehicle before changing may be transferred to the vehicle after change.

What is claimed is:

1. An in-vehicle system comprising:
a driving proficiency acquisition unit acquiring a driving proficiency level of a driver;
a driving proficiency determination unit determining the driving proficiency level of the driver; and
a function learning presentation unit presenting learning of functions to the driver in stepwise manner according to a determination result of the driving proficiency level of the driver.

2. The in-vehicle system according to claim 1, wherein
the driving proficiency acquisition unit acquires, as the driving proficiency level of the driver, vehicle data and driving ability data of the driver.

3. The in-vehicle system according to claim 1, wherein
the function learning presentation unit presents the learning of functions to the driver in stepwise manner under a condition that a safety of driving operation is secured.

4. The in-vehicle system according to claim 1, further comprising
a learning status acquisition unit acquiring a learning status of one of the functions;
a learning status determination unit determining the learning status of one of the functions; and
a learning determination result notification unit notifying a determination result of the learning status of one of the functions.

5. The in-vehicle system according to claim 1, wherein
the function learning presentation unit presents learning of next one of the functions to the driver when a learning status of one of the functions is determined to reach a predetermined level.

6. The in-vehicle system according to claim 1, further comprising
a function suppression unit suppressing the functions when a predetermined period of time is elapsed from last driving operation of the driver,
wherein the function learning presentation unit presents suppression of the functions to the driver when the functions are suppressed by the function suppression unit.

7. The in-vehicle system according to claim 1, further comprising
a function suppression unit suppressing the functions when the driving proficiency level of the driver decreases to a reference level,
wherein the function learning presentation unit presents suppression of the functions to the driver when the functions are suppressed by the function suppression unit.

8. The in-vehicle system according to claim 1, wherein
the function learning presentation unit determines whether the learning of functions is possible according to a determination result of the driving proficiency level, and
in response to determining that the learning of functions is possible, the function learning presentation unit presents pre-learning of the functions to the driver.

9. The in-vehicle system according to claim 8, wherein
the function learning presentation unit presents the pre-learning of the functions to the driver using simulation during driving operation.

10. The in-vehicle system according to claim 1, further comprising
a driving operation history acquisition unit acquiring driving operation history of another driver;
a vehicle setting information acquisition unit acquiring vehicle setting information of another driver from the acquired driving operation history of another driver; and
a vehicle setting information changing unit changing vehicle setting information of the driver in accordance with the vehicle setting information of another driver.

11. The in-vehicle system according to claim 10, wherein
the vehicle setting information changing unit changes the vehicle setting information of the driver according to at least one of (i) the driving proficiency level of the driver, (ii) preference of the driver, or (iii) viewpoint direction of the driver.

12. A computer-readable non-transitory storage medium storing a computer program, the computer program comprising instructions to be executed by at least one processor of an in-vehicle system for presenting functions to be learned by a driver of a vehicle, the instructions of the computer program comprising:
acquiring a driving proficiency level of the driver;
determining the driving proficiency level of the driver; and
presenting learning of functions to the driver in stepwise manner according to a determination result of the driving proficiency level of the driver.

13. An in-vehicle system comprising:
a computer-readable non-transitory storage medium; and
a microcomputer, by executing a program stored in the computer-readable non-transitory storage, configured to:
acquire a driving proficiency level of a driver,
determine the driving proficiency level of the driver, and
present learning of functions to the driver in stepwise manner according to a determination result of the driving proficiency level of the driver.
